(19) United States
(12) Patent Application Publication
(10) Pub. No.: US 2014/0357773 A1
(43) Pub. Date: Dec. 4, 2014

(54) Silicone Resin Emulsions

(71) Applicant: Dow Corning Corporation, MIDLAND, MI (US)

(72) Inventors: Donald Taylor Liles, Midland, MI (US); Timothy Paul Mitchell, Clio, MI (US)

(73) Assignee: Dow Corning Corporation, Midland, MI (US)

(21) Appl. No.: 14/372,285

(22) PCT Filed: Feb. 5, 2013
(86) PCT No.: PCT/US13/24761

§ 371 Date: Jul. 15, 2014

Related U.S. Application Data
(60) Provisional application No. 61/596,320, filed on Feb. 8, 2012.
(60) Provisional application No. 61/596,453, filed on Feb. 8, 2012.
(60) Provisional application No. 61/596,324, filed on Feb. 8, 2012.

(51) Int. Cl. C09J 183/04; B05D 3/00; C09D 183/06; C09J 183/06; C09D 183/04

(52) U.S. Cl. CPC C09J 183/04; C09J 183/06; C09D 183/04; C09D 183/06; B05D 3/007
USPC 524/377; 427/387

(57) ABSTRACT

A process for preparing silicone emulsions is disclosed based on using an ethylene oxide/propylene oxide block copolymer as the emulsifier. The silicone emulsions comprise: A) 0.5 wt % to 95 wt % of a silicone resin or pressure sensitive adhesive (PSA), B) 0.1 to 90 wt % of a ethylene oxide/propylene oxide block copolymer, and sufficient amount of water to sum to 100 weight percent. The present disclosure further relates to a process for making a silicone resin emulsion comprising: I) forming a dispersion of; A) 100 parts of a silicone resin or PSA, B) 5 to 100 parts of a ethylene oxide/propylene oxide block copolymer, II) admixing a sufficient amount of water to the dispersion from step I) to form an emulsion, III) optionally, further shear mixing the emulsion.

### CROSS-REFERENCE TO RELATED APPLICATIONS

This application claims the benefit of U.S. application Ser. No. 61/596,320 as filed on 8 Feb. 2012, U.S. application Ser. No. 61/596,324 as filed on 8 Feb. 2012, and U.S. application Ser. No. 61/596,453 as filed on 8 Feb. 2012. U.S. application Ser. Nos. 61/596,320, 61/596,324, and 61/596,453 are herein incorporated by reference in their entirety.

### BACKGROUND OF THE INVENTION

Silicone resins and pressure sensitive adhesives (PSAs) are used in many industrial applications such as in the coatings industry. Preparation of aqueous mechanical emulsions of silicone resins or PSAs is difficult due to the handling of such highly molecular weight and/or solid materials. Often, the silicone resin or PSA is dissolved in an organic aromatic solvent, or require specialized surfactants containing aromatic solvents. The presence of such solvents presents manufacturing challenges and also precludes their use in many personal or healthcare applications. Silicone resins or PSAs can be emulsified using specialized equipment such as a twin screw extruder (TSE). However, the costs for such equipment are relatively high, both from a capital and an operational standpoint.

Thus, there exists a need to identify processes to prepare mechanical emulsions of silicone resins or PSAs that do not require specialized surfactants containing aromatic solvents, or require expensive emulsification equipment.

### BRIEF SUMMARY OF THE INVENTION

The present inventors have discovered that mechanical emulsions of silicone resins or PSAs may be readily prepared in simple equipment using a specific class of certain nonionic surfactants, namely poly(oxyethylene)-poly(oxypropylene)-poly(oxyethylene) block copolymers. The present disclosure relates to aqueous silicone resin emulsions comprising:
A) 0.5 wt % to 95 wt % of a silicone resin or PSA,
B) 0.1 to 90 wt % of a ethylene oxide/propylene oxide block copolymer,
and sufficient amount of water to sum to 100 weight percent.

The present disclosure further relates to a process for making a silicone resin or PSA emulsion comprising:

I) forming a dispersion of;
A) 100 parts of a silicone resin or PSA,
B) 5 to 100 parts of a ethylene oxide/propylene oxide block copolymer,
   II) admixing a sufficient amount of water to the dispersion from step I) to form an emulsion,
   III) optionally, further shear mixing the emulsion.

The present disclosure relates to coating compositions comprising:
i) an aqueous silicone resin emulsion comprising;
   A) 0.5 wt % to 95 wt % of a silicone resin,
   B) 0.1 to 90 wt % of an ethylene oxide/propylene oxide block copolymer,
   and sufficient amount of water to sum all ingredients of the silicone resin emulsion to 100 weight percent,
ii) at least one coating additive, and
iii) an optional solvent(s).

The present disclosure further provides methods of improving the coefficient of friction, the water resistance, repellency, anti-blocking, slip abrasion, scratch, burnish resistance, anti-squeak, touch, anti-fouling or anti-graffiti properties of a coating by applying a film of the present coating compositions to a surface, and curing the film to form a coating.

This disclosure further relates to the use of the present compositions in an ink formulation, over print varnish, wood coating, industrial, flame retardant, high temperature resistance, protective coating, automotive weather stripping, cookware, bakeware, architectural, coil, can, plastic coatings, auto OEM and refinish, aerospace, marine, glass coating, or leather coating formulation.

### DETAILED DESCRIPTION OF THE INVENTION

### A) The Silicone Resin or Pressure Sensitive Adhesive (PSA)

Component A) may be either a silicone resin or PSA. As used herein, “silicone resin” refers to any organopolysiloxane containing at least one (RSiO_{3/2}), or (SiO_{4/2}) siloxy unit. As used herein in its broadest sense, a silicone PSA refers to the reaction products resulting from reacting a hydroxyl endblocked “linear” organopolysiloxane with a “resin” organopolysiloxane, wherein the resin organopolysiloxane contains at least one (RSiO_{3/2}), or (SiO_{4/2}) siloxy unit.

Organopolysiloxanes are polymers containing siloxy units independently selected from (R₃SiO_{1/2}), (R₂SiO_{2/2}), (RSiO_{3/2}), or (SiO_{4/2}) siloxy units, where R may be any organic group. These siloxy units are commonly referred to as M, D, T, and Q units respectively. These siloxy units can be combined in various manners to form cyclic, linear, or branched structures. The chemical and physical properties of the resulting polymeric structures vary depending on the number and type of siloxy units in the organopolysiloxane. “Linear” organopolysiloxanes typically contain mostly D or (R₂SiO_{2/2}) siloxy units, which results in polydiorganosiloxanes that are fluids of varying viscosity, depending on the “degree of polymerization” or DP as indicated by the number of D units in the polydiorganosiloxane. “Linear” organopolysiloxanes typically have glass transition temperatures (T_{g}) that are lower than 25° C. “Resin” organopolysiloxanes result when a majority of the siloxy units are selected from T or Q siloxy units. When T siloxy units are predominately used to prepare an organopolysiloxane, the resulting organosiloxane is often referred to as a “silsesquioxane resin”. When M and Q siloxy units are predominately used to prepare an organopolysiloxane, the resulting organosiloxane is often referred to as a “MQ resin”. Alternatively, the formula for an organopolysiloxane may be designated by the average of the siloxy units in the organopolysiloxane as follows; RₙSiO_{(4-n)/2}, where the R is independently any organic group, alternatively a hydrocarbon, or alternatively an alkyl group, or alternatively methyl. The value of n in the average formula may be used to characterize the organopolysiloxane. For example, an average value of n=1 would indicate a predominate concentration of the (RSiO_{3/2}) siloxy unit in the organopolysiloxane, while n=2 would indicate a predominance of (R₂SiO_{2/2}) siloxy units. As used herein, “organopolysiloxane resin” refers to those organopolysiloxanes having a value of n less than 1.8 in the average formula RₙSiO_{(4-n)/2}, indicating a resin.

The silicone resin useful as component A) may independently comprise (i) (R¹₃SiO_{1/2})ₐ , (ii) (R²₂SiO_{2/2})_{b} , (iii) (R³SiO_{3/2})_{c}, and (iv) (SiO_{4/2})_{d} siloxy units, providing there is at least one T or Q siloxy unit in the silicone resin molecule. The amount of each unit present in the silicone resin is expressed as a mole fraction (i.e. a, b, c, or d) of the total number of moles of all M, D, T, and Q units present in the silicone resin. Any such formula used herein to represent the silicone resin does not indicate structural ordering of the various siloxy units. Rather, such formulae are meant to provide a convenient notation to describe the relative amounts of the siloxy units in the silicone resin, as per the mole fractions described above via the subscripts a, b, c, and d. The mole fractions of the various siloxy units in the present organosiloxane block copolymers, as well as the silanol content, may be readily determined by ²⁹Si NMR techniques.

The silicone resin may also contain silanol groups (SiOH). The amount of silanol groups present on the silicone resin may vary from 0.1 to 35 mole percent silanol groups [≡SiOH], alternatively from 2 to 30 mole percent silanol groups [≡SiOH], alternatively from 5 to 20 mole percent silanol groups [≡SiOH]. The silanol groups may be present on any siloxy units within the silicone resin.

The molecular weight of the silicone resin is not limiting. The silicone resin may have an average molecular weight (M_{w}) of at least 1,000 g/mole, alternatively an average molecular weight of at least 2,000 g/mole alternatively an average molecular weight of at least 5,000 g/mole. The average molecular weight may be readily determined using Gel Permeation Chromatography (GPC) techniques.

In one embodiment, the silicone resin is a MQ silicone. The silicone resin may be a MQ resin comprising at least 80 mole % of siloxy units selected from (R¹₃SiO_{1/2})ₐ and (SiO_{4/2})_{d} units (that is a+d≧0.8), where R¹ is an alkyl group having from 1 to 8 carbon atoms, an aryl group, a carbinol group, or an amino group, with the proviso that at least 95 mole % of the R¹ groups are alkyl groups, a and d each have a value greater than zero, and the ratio of a/d is 0.5 to 1.5.

The R¹ units of the MQ resin are independently an alkyl group having from 1 to 8 carbon atoms, an aryl group, a carbinol group, or an amino group. The alkyl groups are illustrated by methyl, ethyl, propyl, butyl, pentyl, hexyl, and octyl. The aryl groups are illustrated by phenyl, naphthyl, benzyl, tolyl, xylyl, xenyl, methylphenyl, 2-phenylethyl, 2-phenyl-2-methylethyl, chlorophenyl, bromophenyl and fluorophenyl with the aryl group typically being phenyl.

MQ resins suitable for use as component (A), and methods for their preparation, are known in the art. For example, U.S. Pat. No. 2,814,601 to Currie et al., Nov. 26, 1957, which is hereby incorporated by reference, discloses that MQ resins can be prepared by converting a water-soluble silicate into a silicic acid monomer or silicic acid oligomer using an acid. When adequate polymerization has been achieved, the resin is end-capped with trimethylchlorosilane to yield the MQ resin. Another method for preparing MQ resins is disclosed in U.S. Pat. No. 2,857,356 to Goodwin, Oct. 21, 1958, which is hereby incorporated by reference. Goodwin discloses a method for the preparation of an MQ resin by the cohydrolysis of a mixture of an alkyl silicate and a hydrolyzable trialkylsilane organopolysiloxane with water.

The MQ resins suitable as component A) in the present invention may contain D and T units. The MQ resins may also contain hydroxy groups. Typically, the MQ resins have a total weight % hydroxy content of 2-10 weight %, alternatively 2-5 weight %. The MQ resins can also be further “capped” wherein residual hydroxy groups are reacted with additional M groups.

In one embodiment, the silicone resin is a silsesquioxane resin. The silsesquioxane resin may be a silsesquioxane resin comprising at least 80 mole % of R³SiO_{3/2} units, where R³ in the above trisiloxy unit formula is independently a C₁ to C₂₀ hydrocarbyl, a carbinol group, or an amino group. As used herein, hydrocarbyl also includes halogen substituted hydrocarbyls. R³ may be an aryl group, such as phenyl, naphthyl, anthryl group. Alternatively, R³ may be an alkyl group, such as methyl, ethyl, propyl, or butyl. Alternatively, R³ may be any combination of the aforementioned alkyl or aryl groups. Alternatively, R³ is phenyl, propyl, or methyl. In one embodiment, at least 40 mole % of the R³ groups are propyl, referred herein as T-propyl resins, since the majority of the siloxane units are T units of the general formula R³SiO_{3/2} where at least 40 mole %, alternatively 50 mole %, or alternatively 90 mole % of the R³ groups are propyl. In another embodiment, at least 40 mole % of the R³ groups are phenyl, referred herein as T-phenyl resins, since the majority of the siloxane units are T units of the general formula R³SiO_{3/2} where at least 40 mole %, alternatively 50 mole %, or alternatively 90 mole % of the R³ groups are phenyl. In yet another embodiment, R³ may be a mixture of propyl and phenyl. When R³ is a mixture of propyl and phenyl, the amounts of each in the resin may vary, but typically the R³ groups in the silsesquioxane resin may contain 60-80 mole percent phenyl and 20-40 mole percent propyl.

Silsesquioxane resins are known in the art and are typically prepared by hydrolyzing an organosilane having three hydrolyzable groups on the silicon atom, such as a halogen or alkoxy group. Thus, silsesquioxane resins can be obtained by hydrolyzing propyltrimethoxysilane, propyltriethoxysilane, propyltripropoxysilane, or by co-hydrolyzing the aforementioned propylalkoxysilanes with various alkoxysilanes. Examples of these alkoxysilanes include methyltrimethoxysilane, methyltriethoxysilane, methyltriisopropoxysilane, dimethyldimethoxysilane, and phenyltrimethoxysilane. Propyltrichlorosilane can also be hydrolyzed alone, or in the presence of alcohol. In this case, co-hydrolyzation can be carried out by adding methyltrichlorosilane, dimethyldichlorosilane, phenyltrichlorosilane, or similar chlorosilanes and methyltrimethoxysilane, methyltriethoxysilane, methyltriisopropoxysilane, or similar methylalkoxysilane. Alcohols suitable for these purposes include methanol, ethanol, n-propyl alcohol, isopropyl alcohol, butanol, methoxy ethanol, ethoxy ethanol, or similar alcohols. Examples of hydrocarbon-type solvents which can also be concurrently used include toluene, xylene, or similar aromatic hydrocarbons; hexane, heptane, isooctane, or similar linear or partially branched saturated hydrocarbons; and cyclohexane, or similar aliphatic hydrocarbons.

The silsesquioxane resins suitable in the present disclosure may contain M, D, and Q units, but typically at least 80 mole %, alternatively 90 mole % of the total siloxane units are T units. The silsesquioxane resins may also contain hydroxy and/or alkoxy groups. Typically, the silsesquioxane resins have a total weight % hydroxy content of 2-10 weight % and a total weight % alkoxy content of up to 20 weight %, alternatively 6-8 weight % hydroxy content and up to 10 weight % alkoxy content.

Representative, non-limiting examples of commercial silicone resins suitable as component A) include; silicone resins sold under the trademarks DOW CORNING® 840 Resin, DOW CORNING® 2-7466 Resin, DOW CORNING® 2-9138 Resin, DOW CORNING® 2-9148 Resin, DOW CORNING® 2104 Resin, DOW CORNING® 2106 Resin, DOW CORNING® 217 Flake Resin, DOW CORNING® 220 Flake Resin, DOW CORNING® 233 Flake Resin, DOW CORNING® 4-2136 Resin, Xiameter® RSN-6018 Resin, Xiameter® RSN-0217 Resin, Silres® MK methyl silicone resin, Dow Corning® MQ 1600 Resin.

As used herein, “silicone resin” also encompasses silicone-organic resins. Thus, silicone-organic resins includes silicone-organic copolymers, where the silicone portion contains at least one (RSiO_{3/2}), or (SiO_{4/2}) siloxy unit. The silicone portion of the silicone-organic resin may be any of the silisesquioxane or MQ resins as described above. The organic portion may be any organic polymer, such as those derived by free radical polymerization of one or more ethylenically unsaturated organic monomers. Various types of ethylenically unsaturated and/or vinyl containing organic monomers can be used to prepare the organic portion including; acrylates, methacrylates, substituted acrylates, substituted methacrylates, vinyl halides, fluorinated acrylates, and fluorinated methacrylates, for example. Some representative compositions include acrylate esters and methacrylate esters such as methyl acrylate, ethyl acrylate, butyl acrylate, 2-ethylhexyl acrylate, methyl methacrylate, decyl acrylate, lauryl acrylate, isodecyl methacrylate, lauryl methacrylate, and butyl methacrylate; substituted acrylates and methacrylates such as hydroxyethyl acrylate, perfluorooctyl acrylate, hydroxypropyl acrylate, hydroxypropyl methacrylate, and hydroxyethyl methacrylate; vinyl halides such as vinyl chloride, vinylidene chloride, and chloroprene; vinyl esters such as vinyl acetate and vinyl butyrate; vinyl pyrrolidone; conjugated dienes such as butadiene and isoprene; vinyl aromatic compounds such as styrene and divinyl benzene; vinyl monomers such as ethylene; acrylonitrile and methacrylonitrile; acrylamide, methacrylamide, and N-methylol acrylamide; and vinyl esters of monocarboxylic acids

The silicone resin selected as component A) may also be a combination(s) of any of the aforementioned silicone resins.

When component A) is a silicone PSA, it may be the reaction product of a hydroxy endblocked polydimethylsiloxane polymer and a hydroxy functional silicate or silicone resin. Typically, the hydroxy functional silicate resin is a trimethylsiloxy and hydroxy endblocked silicate resin, such as the silicone resins described above. The polydimethylsiloxane polymer and hydroxy functional silicate resin are reacted in a condensation reaction to form the silicone PSA.

PSAs are disclosed in U.S. Pat. Nos. 4,584,355; 4,585,836; 4,591,622; 5,726,256; 5,776,614; 5,861,472; 5,869,556; 6,337086, all of which are hereby incorporated by reference for the purpose of disclosing the chemical compositions of PSAs useful as component A) in the present disclosure.

The silicone PSA may also be a silicone acrylate hybrid composition, as disclosed in WO2007/145996, which is incorporated herein by reference for its teaching of suitable PSA compositions as component A).

Representative, non-limiting examples of commercially available PSA's suitable as component A) include; Dow Corning® Q2-7406 Adhesive, Dow Corning® Q2-7735 Adhesive, Dow Corning® 7355 Adhesive, Dow Corning® 7358 Adhesive, Dow Corning® Q2-7566 Adhesive, Dow Corning® 7-4100 Adhesive, Dow Corning® 7-4200 Adhesive, Dow Corning® 7-4300 Adhesive, Dow Corning® 7-4400 Adhesive, Dow Corning® 7-4500 Adhesive, Dow Corning® 7-4600 Adhesive, Dow Corning® 7-4560, Shin-Etsu KR-100, Shin-Etsu KR-101-10, Shin-Etsu SR-130 Momentive PSA518, Momentive SPUR+PSA 3.0, Momentive SILGRIP PSA529, Momentive SILGRIP PSA915, Momentive SILGRIP PSA610, Momentive SILGRIP PSA595, Momentive SILGRIP PSA6374, and Momentive SILGRIP PSA6574.

### B) The Ethylene Oxide/Propylene Oxide Block Copolymer

Component B) is an ethylene oxide/propylene oxide block copolymer. Component B) may be selected from those ethylene oxide/propylene oxide block copolymers known to have surfactant behavior. Typically, the ethylene oxide/propylene oxide block copolymers useful as component B) are surfactants having an HLB of at least 12, alternatively, at least 15, or alternatively at least 18.

The molecular weight of the ethylene oxide/propylene oxide block copolymer may vary, but typically is at least 4,000 g/mol, alternatively at least 8,000 g/mol, or at least 12,000 g/mol.

The amounts of ethylene oxide (EO) and propylene oxide (PO) present in the ethylene oxide/propylene oxide block copolymer may vary, but typically, the amount of EO may vary from 50 percent to 80 percent, or alternatively from 60 percent to about 85 percent, or alternatively from 70 percent to 90 percent.

In one embodiment, component B) is a poly(oxyethylene)-poly(oxypropylene)-poly(oxyethylene) tri-block copolymer. Poly(oxyethylene)-poly(oxypropylene)-poly(oxyethylene) tri-block copolymers are also commonly known as Poloxamers. They are nonionic triblock copolymers composed of a central hydrophobic chain of polyoxypropylene (poly(propylene oxide)) flanked by two hydrophilic chains of polyoxyethylene (poly(ethylene oxide)).

Poly(oxyethylene)-poly(oxypropylene)-poly(oxyethylene) tri-block copolymers are commercially available from BASF (Florham Park, NJ) and are sold under the tradename PLURONIC®. Representative, non-limiting examples suitable as component (B) include; PLURONIC® F127, PLURONIC® F98, PLURONIC® F88, PLURONIC® F87, PLURONIC® F77 and PLURONIC® F68, and PLURONIC® F-108.

In a further embodiment, the poly(oxyethylene)-poly(oxypropylene)-poly(oxyethylene) tri-block copolymer has the formula;

HO(CH₂CH₂O)ₘ(CH₂CH(CH₃)O)ₙ(CH₂CH₂O)ₘH
where the subscript “m” may vary from 50 to 400, or alternatively from 100 to 300,
and the subscript “n” may vary from 20 to 100, or alternatively from 25 to 100.

In one embodiment, component B) is a tetrafunctional poly(oxyethylene)-poly(oxypropylene) block copolymer derived from the sequential addition of propylene oxide and ethylene oxide to ethylene diamine. These tetra-functional block copolymers are also commonly known as Poloxamines. The tetrafunctional poly(oxyethylene)-poly(oxypropylene) block copolymer may have the average formula;

[HO(CH₂CH₂O)_{q}(CH₂CH(CH₃)O)ᵣ]₂NCH₂CH₂N[(CH₂CH(CH₃)O)ᵣ(CH₂CH₂O)_{q}H]₂,
where the subscript “q” may vary from 50 to 400, or alternatively from 100 to 300,
and the subscript “r” may vary from 15 to 75, or alternatively from 20 to 50.

Tetrafunctional poly(oxyethylene)-poly(oxypropylene) block copolymers are commercially available from BASF (Florham Park, NJ) and are sold under the tradename TETRONIC®. Representative, non-limiting examples suitable as component (B) include; TETRONIC® 908, TETRONIC® 1107, TETRONIC® 1307, TETRONIC® 1508 and TETRONIC® 1504.

The amounts of components A) and B) may vary in the emulsion. Typically the silicone resin emulsions comprise, alternatively consists essentially of, or alternatively consists of:
0.5 to 95 wt. % of A) the silicone resin;
   alternatively 5 to 90 wt. % of A) silicone resin,
      alternatively 10 to 80 wt. % of A) silicone resin,
         alternatively 20 to 70 wt. % of A) silicone resin,
            alternatively 30 to 60 wt. % of A) silicone resin,
0.1 to 90 wt. % of B) the ethylene oxide/propylene oxide block copolymer;
   alternatively 0.1 to 50 wt. % of B) the block copolymer,
      alternatively 0.5 to 40 wt. % of B) the block copolymer,
         alternatively 1 to 30 wt. % of B) the block copolymer,
            alternatively 1 to 20 wt. % of B) the block copolymer,
            alternatively 1 to 10 wt. % of B) the block copolymer,
               and sufficient amounts of water, or other components, to sum to 100 wt %.

Other additives can also be incorporated in the emulsions of the present disclosure, such as fillers, preservatives, biocides, freeze/thaw additives, anti-freeze agents, various thickeners, viscosity modifiers, and foam control agents.

The emulsion compositions of the present disclosure may be an oil/water emulsion, a water/oil emulsion, a multiple phase or triple emulsion.

In one embodiment, the emulsion products produced by the present process are “oil/water emulsions”, that is, an emulsion having an aqueous continuous phase and a dispersed phase comprising the silicone resin. The oil/water emulsion may be characterized by average volume particle of the dispersed silicone resin (oil) phase in a continuous aqueous phase. The particle size may be determined by laser diffraction of the emulsion. Suitable laser diffraction techniques are well known in the art. The particle size is obtained from a particle size distribution (PSD). The PSD can be determined on a volume, surface, length basis. The volume particle size is equal to the diameter of the sphere that has the same volume as a given particle. The term Dv represents the average volume particle size of the dispersed particles. Dv 50 is the particle size measured in volume corresponding to 50% of the cumulative particle population. In other words if Dv 50=10 μm, 50% of the particle have an average volume particle size below 10 μm and 50% of the particle have a volume average particle size above 10 μm. Dv 90 is the particle size measured in volume corresponding to 90% of the cumulative particle population.

The average volume particle size of the dispersed silicone particles in the oil/water emulsions is between 0.1 μm and 150 μm; or between 0.1 μm and 30 μm; or between 0.3 μm and 5.0 μm.

The present emulsions may be prepared by any known methods, or alternatively prepared by the methods as discussed below.

The present disclosure further provides a process for making a silicone resin emulsion comprising;
I) forming a dispersion of;
   A) 100 parts of a silicone resin or PSA,
   B) 5 to 100 parts of a ethylene oxide/propylene oxide block copolymer,
II) admixing a sufficient amount of water to the dispersion from step I) to form an emulsion,
III) optionally, further shear mixing the emulsion.

The amount of components A) and B) combined in step I) are as follows;
A) 100 parts of a silicone resin or PSA, and
B) 5 to 100 parts, alternatively 10 to 40 parts, or alternatively 10 to 25 of the ethylene oxide/propylene oxide block copolymer. Components A) and B) are the same as described above.

As used herein, “parts” refers to parts by weight.

In one embodiment, the dispersion formed in step I) consists essentially of components A) and B) as described above. In this embodiment, no additional surfactants or emulsifiers are added in step I). Furthermore, no solvents are added for the purpose of enhancing formation of an emulsion. As used herein, the phrase “essentially free of “solvents” means that solvents are not added to components A) and B) in order to create a mixture of suitable viscosity that can be processed on typical emulsification devices. More specifically, “solvents” as used herein is meant to include any water immiscible low molecular weight organic or silicone material added to the non-aqueous phase of an emulsion for the purpose of enhancing the formation of the emulsion, and is subsequently removed after the formation of the emulsion, such as evaporation during a drying or film formation step. Thus, the phrase “essentially free of solvent” is not meant to exclude the presence of solvent in minor quantities in process or emulsions of the present invention. For example, there may be instances where the components A) and B) may contain minor amounts of solvent as supplied commercially. Small amounts of solvent may also be present from residual cleaning operations in an industrial process. Preferably, the amount of solvent present in the premix should be less than 2% by weight of the mixture, and most preferably the amount of solvent should be less than 1% by weight of the mixture.

The dispersion of step (I) may be prepared by combining components A) and B) and further mixing the components to form a dispersion. The resulting dispersion may be considered as a homogenous mixture of the two components. The present inventors have unexpectedly found that certain ethylene oxide/propylene oxide block copolymers readily disperse with silicone resin compositions, and hence enhance the subsequent formation of emulsion compositions thereof. The present inventors believe other nonionic and/or anionic surfactants, typically known for preparing silicone emulsions, do not form such dispersions or homogeneous mixtures upon mixing with a silicone resin (at least not in the absence of a solvent or other substance to act as a dispersing medium). While not wishing to be limited to any theory, the inventors believe the discovery of the present ethylene oxide/propylene oxide block copolymers to form such dispersions with silicone resins, provides emulsion compositions of silicone resins without the presence of undesirable solvents, or requiring elaborate handling/mixing techniques.

Mixing can be accomplished by any method known in the art to effect mixing of high viscosity materials. The mixing may occur either as a batch, semi-continuous, or continuous process. Mixing may occur, for example using, batch mixing equipments with medium/low shear include change-can mixers, double-planetary mixers, conical-screw mixers, ribbon blenders, double-arm or sigma-blade mixers; batch equipments with high-shear and high-speed dispersers include those made by Charles Ross & Sons (NY), Hockmeyer Equipment Corp. (NJ); batch mixing equipment such as those sold under the tradename Speedmixer®; batch equipments with high shear actions include Banbury-type (CW Brabender Instruments Inc., NJ) and Henschel type (Henschel mixers America, TX). Illustrative examples of continuous mixers/compounders include extruders single-screw, twin-screw, and multi-screw extruders, co-rotating extruders, such as those manufactured by Krupp Werner & Pfleiderer Corp (Ramsey, NJ), and Leistritz (NJ); twin-screw counter-rotating extruders, two-stage extruders, twin-rotor continuous mixers, dynamic or static mixers or combinations of these equipments.

The process of combining and mixing components A) and B) may occur in a single step or multiple step process. Thus, components A) and B) may be combined in total, and subsequently mixed via any of the techniques described above. Alternatively, a portion(s) of components A) and B) may first be combined, mixed, and followed by combining additional quantities of either or both components and further mixing. One skilled in the art would be able to select optimal portions of components A) and B) for combing and mixing, depending on the selection of the quantity used and the specific mixing techniques utilized to perform step I) to provide a dispersion of components A) and B).

Step II of the process involves admixing sufficient water to the mixture of step I to form an emulsion. Typically 5 to 700 parts water are mixed for every 100 parts of the step I mixture to form an emulsion. In one embodiment the emulsion formed is a water continuous emulsion. Typically, the water continuous emulsion has dispersed particles of the silicone resin from step I, and having an average particle size less than 150 μm.

The amount of water added in step II) can vary from 5 to 700 parts per 100 parts by weight of the mixture from step I. The water is added to the mixture from step I at such a rate so as to form an emulsion of the mixture of step I. While this amount of water can vary depending on the selection of the amount of silicone resin present and the specific ethylene oxide/propylene oxide block copolymer used, generally the amount of water is from 5 to 700 parts per 100 parts by weight of the step I mixture, alternatively from 5 to 100 parts per 100 parts by weight of the step I mixture, or alternatively from 5 to 70 parts per 100 parts by weight of the step I mixture.

Typically the water is added to the mixture from step I in incremental portions, whereby each incremental portion comprises less than 30 weight % of the mixture from step I and each incremental portion of water is added successively to the previous after the dispersion of the previous incremental portion of water, wherein sufficient incremental portions of water are added to form an emulsion.

Alternatively, a portion or all the water used in step I) may be substituted with various hydrophilic solvents that are soluble with water such as low molecular weight alcohols, ethers, esters or glycols. Representative non-limiting examples include low molecular weight alcohols such as methanol, ethanol, propanol, isopropanol and the like; low molecular weight ethers such as di(propyleneglycol) mono methyl ether, di(ethyleneglycol) butyl ether, di(ethyleneglycol) methyl ether, di(propyleneglycol) butyl ether, di(propyleneglycol) methyl ether acetate, di(propyleneglycol) propyl ether, ethylene glycol phenyl ether, propylene glycol butyl ether, 1-methoxy-2-propanol, 1-methoxy-2-propyl acetate, propylene glycol propyl ether, 1-phenoxy-2-propanol, tri(propyleneglycol) methyl ether and tri(propyleneglycol) butyl ether, and other like glycols.

Mixing in step (II) can be accomplished by any method known in the art to affect mixing of high viscosity materials. The mixing may occur either as a batch, semi-continuous, or continuous process. Any of the mixing methods as described for step (I), may be used to affect mixing in step (II). Typically, the same equipment is used to effect mixing in steps I) and II).

Optionally, the water continuous emulsion formed in step (II) may be further sheared according to step (III) to reduce particle size and/or improve long term storage stability. The shearing may occur by any of the mixing techniques discussed above.

The present disclosure relates to the emulsions produced by the aforementioned processes.

The emulsions of the present disclosure may be further characterized by the properties of the resulting films or coatings produced after allowing a film of the emulsion to dry. Typically, such coatings are obtained by forming a film of the emulsion on a surface, and allowing the film to stand for a sufficient period of time to evaporate the water present in the emulsion, which allows the silicone composition to cure. This process may be accelerated by increasing the ambient temperature of the film or coating.

In one embodiment, the resulting cured film is transparent and/or tack free.

The present disclosure further provides compositions comprising at least one coating additive. As used herein, “coating additive” refers to an organic resin, dispersions or emulsions of organic resins, pigments, binders, flame retardants, and other components that are known in the art to prepare coating compositions used to protect/coat for example; wood, cookware/bakeware, electronic devices, architectural surfaces, industrial surfaces, auto OEM, aerospace, automotive interiors, foils, coils, cans, plastics, marine surfaces, glass, leather and textile.

The coating additive may comprise an organic resins or emulsions of polyurethane, acrylics, Si-acrylics, epoxy, alkyd, polyurethane-acrylic, polyester, Si-polyester, styrene-acrylic, vinyl acetate, fluoropolymer, vinyl polymer or blends of.

In one embodiment, the present coating compositions contain an acrylic emulsion as the coating additive. As used herein “acrylic emulsions” refer to any water based emulsion of a polyacrylate, polymethacrylate, or other similar copolymers derived from acrylic or methacrylic acid. Many acrylic emulsions are available commercially for ready use in paints and coating formulations. These acrylic emulsions are often described as self-crosslinkable acrylic emulsions, which may be used in the present coating compositions. Representative self-crosslinkable acrylic emulsions include useful in the present compositions include; ALBERDINGK AC 2514, ALBERDINGK AC 25142, ALBERDINGK AC 2518, ALBERDINGK AC 2523, ALBERDINGK AC 2524, ALBERDINGK AC 2537, ALBERDINGK AC 25381, ALBERDINGK AC 2544, ALBERDINGK AC 2546, ALBERDINGK MAC 24, and ALBERDINGK MAC 34 polymer dispersions from Alberdingk Boley, Inc.; EPS 2538 and EPS 2725 acrylic emulsions from EPS Corp.; RHOPLEX™ 3131-LO, RHOPLEX E-693, RHOPLEX E-940, RHOPLEX E-1011, RHOPLEX E-2780, RHOPLEX HG-95P, RHOPLEX HG-700, RHOPLEX HG-706, RHOPLEX PR-33, RHOPLEX TR-934HS, RHOPLEX TR-3349 and RHOPLEX™ VSR-1050 acrylic emulsions from Rohm and Haas Co.; RHOSHIELD™ 636 and RHOSHIELD 3188 polymer dispersions from Rohm and Haas Co; JONCRYL® 8380, 8300, 8211, 1532, 1555, 2560, 1972, 1980, 1982, and 1984 acrylic emulsions from BASF Corp.; NEOCRYL™ A-1127, NEOCRYL A-6115, NEOCRYL XK-12, NEOCRYL XK-90, NEOCRYL, XK-98 and NEOCRYL XK-220 acrylic latex polymers from DSM NeoResins, Inc., and mixtures thereof. In one embodiment, the acrylic emulsion is JONCRYL® 8383 acrylic emulsion from BASF Corp.

The present coating compositions optionally may also contain a solvent. The solvent may be selected from any organic solvents that are typically used to prepare coating compositions. The organic solvent may include a combination of two or more solvents. When used in the coating compositions, the organic solvent may be present in compositions up to a maximum of 90 weight percent of the composition.

In one embodiment, the organic solvent is a glycol solvent. The glycol solvent helps reduce viscosity and may aid wetting or film coalescence. Representative glycol solvents include ethylene glycol, ethylene glycol methyl ether, ethylene glycol ethyl ether, ethylene glycol monobutyl ether, ethylene glycol-2-ethylhexyl ether, propylene glycol, propylene glycol methyl ether, propylene glycol ethyl ether, propylene glycol monobutyl ether, propylene glycol-2-ethylhexyl ether, diethylene glycol, diethylene glycol methyl ether, diethylene glycol ethyl ether, diethylene glycol monobutyl ether, diethylene glycol-2-ethylhexyl ether, dipropylene glycol, dipropylene glycol methyl ether, dipropylene glycol ethyl ether, dipropylene glycol monobutyl ether, dipropylene glycol-2-ethylhexyl ether, and mixtures thereof hydrophilic glycol solvents (e.g., propylene glycol methyl ether or dipropylene glycol monomethyl ether) are preferred.

In one embodiment, the organic solvent is an alcohol. Representative alcohol solvents include both lower molecular weight alcohols; such as methanol, ethanol, propanol, and butanol; as well as branched hydrocarbyl based alcohols like Texanol® solvents; such as 2,2,4-Trimethyl-1,3-pentanediolmono(2-methylpropanoate).

In a further embodiment, the organic solvent is a combination of a glycol and alcohol, as described above.

The present composition may be prepared by combining anyone of the above silicone resin emulsions component i), coating additive(s) ii), and optionally a solvent(s) iii), and mixing. Mixing may be accomplished by simple stirring techniques, or alternatively may involve shear mixing. Any type of mixing and shearing equipment may be used to perform this step such as a batch mixer, planetary mixer, single or multiple screw extruder.

The amounts of components i), ii), and iii) used to prepare the present compositions may vary. In one embodiment, the present composition comprise;
i) 0.01 to 20 weight percent of the silicone resin emulsion as described above;
   alternatively 0.1 to 20 weight percent of the silicone resin emulsion,
   alternatively 1 to 15 weight percent of the silicone resin emulsion, or
   alternatively 1 to 10 weight percent of the silicone resin emulsion,
ii) 1 to 99 weight percent of the coating additive as describe above;
   alternatively 10 to 99 weight percent of the coating emulsion,
   alternatively 50 to 99 weight percent of the coating additive, or
   alternatively 90 to 99 weight percent of the coating additive,
iii) 0 to 90 weight percent of an organic solvent;
   alternatively 1 to 90 weight percent of an organic solvent,
   alternatively 1 to 50 weight percent of an organic solvent, or
   alternatively 1 to 15 weight percent of an organic solvent.

This disclosure further provides a method for improving the coefficient of friction, the water resistance, repellency, anti-blocking, slip abrasion, scratch, burnish resistance, anti-squeak, touch, anti-fouling or anti-graffiti properties of a coating comprising applying a film of the present compositions as described above to a surface, curing the film to form a coating.

This disclosure further relates to the use of the present compositions as described above in an ink formulation, over print varnish, wood coating, industrial, flame retardant, high temperature resistance, protective coating, automotive weather stripping, cookware, bakeware, architectural, coil, can, plastic coatings, auto OEM and refinish, aerospace, marine, glass coating, or leather coating formulation.

### EXAMPLES

The following examples are included to demonstrate certain embodiments of the invention. It should be appreciated by those of skill in the art that the techniques disclosed in the examples which follow represent techniques discovered by the inventors to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention. All percentages are in wt. %. All measurements were conducted at 23° C. unless indicated otherwise.

### Example 1

### Emulsification of Silicone Resin using Pluronic® F-108

The following were weighed into a Max 100 cup in the following order: 35 g silicone flake resin (Xiameter® RSN-6018 Resin) having a number average molecular weight of 1200 and a specific gravity of 1.25, 16 g of 3 mm spherical glass beads (Fisher) and 7 g of Pluronic® F-108 nonionic surfactant. The cup was closed and placed into a DAC-150 SpeedMixer® and the cup was spun at maximum speed (3450 RPM) for two minutes. The cup was opened and inspected. The mixture, which had become very warm, had taken on a creamy white appearance. The cup was closed and allowed to stand undisturbed for five minutes in order for the mixture to cool slightly. The cup was placed back in the mixer and spun for an additional 1 minute at maximum speed. The mixture was diluted with 28 g of deionized (DI) water in five increments by adding aliquots of water and spinning the cup for 25 seconds after addition of each aliquot. The increments of water were as follows: 2 g, 3 g, 5 g, 8 g and 10 g. Following the last dilution, the resulting composition consisted of an o/w emulsion of silicone resin having a silicone content of 50 percent by weight. Particle size of the emulsion was measured using a Malvern® Mastersizer 2000 and found to be: Dv50=0.56 μm; Dv90=0.94 μm. A 4 mil (100 μm) wet film of this emulsion was drawn down onto an aluminum Q-Panel and dried for 24 hours at ambient laboratory temperature. A clear, tack-free film resulted.

### Example 2

### Emulsification of Silicone Resin using Pluronic® F-108

The following were weighed into a Max 100 cup in the following order: 35 g silicone flake resin (Xiameter® RSN-0217 Resin) having a T_{g} of 64° C. and a melt viscosity of 92,000 cP at 107° C., 16 g of 3 mm spherical glass beads (Fisher), 3.15 g of DI water and 10.5 g of Pluronic® F-108 nonionic surfactant. The cup was closed and placed into a DAC-150 SpeedMixer® and the cup was spun at maximum speed (3450 RPM) for two minutes. The cup was opened and inspected. The mixture, which had become very warm, had taken on a creamy white appearance. The cup was closed and allowed to stand undisturbed for five minutes in order for the mixture to cool slightly. The cup was placed back in the mixer and spun for an additional 1 minute at maximum speed. The mixture was diluted with 8 g of DI water in three increments by adding aliquots of water and spinning the cup for 25 seconds after addition of each aliquot. The increments of water were as follows: 1 g, 3 g and 4 g. The mixture was inspected after the last increment of added water and it had appeared to not have inverted, or in other words the composition was a w/o (water-in-oil) emulsion. Next 3.0 g of Carbowax® PEG 1000 (warmed to 50° C. so it was a liquid) was added to the cup and the cup was spun for 30 seconds at maximum speed. Dilution water was added next in three increments of 2 g, 3 g and 5 g such that a total of 10 g of additional water was added. The cup was spun for 20 seconds at maximum speed between each water addition. The total amount of water added was 21.15 g. Following the last dilution, the resulting composition consisted of an o/w, of silicone resin having a silicone content of 50 percent by weight and having a milky white appearance. Particle size of the emulsion was measured using a Malvern® Mastersizer 2000 and found to be: Dv50=0.36 μm; Dv90=3.67. A 4 mil (100μm) wet film of this emulsion was drawn down onto an aluminum Q-Panel and dried for 24 hours at ambient laboratory temperature. A clear, slightly tacky film resulted. The film was dried at 70° C. for four hours after which it became tack-free.

### Example 3

### Emulsification of Methyl Silicone Resin Powder using Pluronic® F-108

The following were weighed into a Max 40 cup in the following order: 10 g methyl silicone resin powder (Silres® MK methyl silicone resin) having a melting range of 35-55° C. and a bulk density of 500 kg/m², 16 g of 3 mm spherical glass beads (Fisher) and 2.5 g of Pluronic® F-108 nonionic surfactant. The cup was closed and placed into a DAC-150 SpeedMixer® and the cup was spun at maximum speed (3450 RPM) for two minutes. The cup was opened and inspected. The mixture, which had become very warm, had taken on a creamy white appearance. The cup was closed, placed back in the mixer and spun for an additional 1 minute at maximum speed. The mixture was diluted with 9.72 g of deionized water in seven increments by adding aliquots of water and spinning the cup for 25 seconds after addition of each aliquot. The increments of water were as follows: 0.3 g, 0.50 g, 0.9 g, 1.4 g, 2.0 g, 2.5 g and 2.12 g. Following the last dilution, the resulting composition consisted of an o/w emulsion of silicone resin having a silicone content of 45 percent by weight. Particle size of the emulsion was measured using a Malvern® Mastersizer 2000 and found to be: Dv50=33.6 μm; Dv90=79.4 μm. A 4 mil (100 μm) wet film of this emulsion was drawn down onto an aluminum Q-Panel and dried for 24 hours at ambient laboratory temperature. A white, tack-free film resulted.

### Example 4

### Emulsification of Trimethylsiloxy Silicate Resin (MQ) Pluronic® F-108

The following were weighed into a Max 40 cup in the following order: 5.0 g of trimethylsiloxy silicate flake resin (Dow Corning® MQ 1600 Resin) having a specific gravity of 1.23, 10 g of 3 mm spherical glass beads (Fisher) and 10.0 g of Pluronic® F-108 nonionic surfactant. The cup was closed and placed into a DAC-150 SpeedMixer® and the cup was spun at maximum speed (3450 RPM) for two minutes. The cup was opened and inspected. The mixture, which had become very warm, had taken on a creamy white appearance. The cup was closed, placed back in the mixer and spun for an additional 1 minute at maximum speed. The mixture was diluted with 20.0 g of deionized water in six increments by adding aliquots of water and spinning the cup for 25 seconds after addition of each aliquot. The increments of water were as follows: 0.5 g, 1.0 g, 2.0 g, 4.0 g, 6.0 g and 6.5 g. Following the last dilution, the resulting composition consisted of a dispersion of silicone resin in water having a silicone content of 14.3 percent by weight. Particle size of the emulsion was measured using a Malvern® Mastersizer 2000 and found to be: Dv50=7.3 μm; Dv90=26.9 μm. The dispersion had the appearance of an opaque paste. A portion of the dispersion was smeared into a film using a spatula and dried at ambient temperature to form a white, coherent, tack-free film.

The following listing describes the silicone PSA's used in the following examples.

SILICONE PSA 1 is a very high tack silicone hot melt PSA, prepared by adding 15% of 100 cSt polydimethylsiloxane fluid to SILICONE PSA 4 (as described below)
SILICONE PSA 2 is an amine-compatible, silicone PSA that is produced through a condensation reaction of a silanol endblocked polydimethylsiloxane (PDMS) with a silicate resin and that is fully capped with trimethylsiloxy groups and is 60% weight solids in ethyl acetate. It is a high tack silicone PSA that has a Resin/Polymer ratio of 55/45.
SILICONE PSA 3 is a conventional, i.e., uncapped, silicone PSA that is produced through a condensation reaction of a silanol endblocked polydimethylsiloxane (PDMS) with a silicate resin and is 60% weight solids in ethyl acetate. It is a low tack silicone PSA that has a Resin/Polymer ratio of 65/35.
SILICONE PSA 4 is a conventional, i.e., uncapped, silicone PSA that is produced through a condensation reaction of a silanol endblocked polydimethylsiloxane (PDMS) with a silicate resin and is 60% weight solids in ethyl acetate. It is a medium tack silicone PSA that has a Resin/Polymer ratio of 60/40.
SILICONE PSA 5 is a conventional, i.e., uncapped, silicone PSA that is produced through a condensation reaction of a silanol endblocked polydimethylsiloxane (PDMS) with a silicate resin and is 60% weight solids in ethyl acetate. It is a high tack silicone PSA that has a Resin/Polymer ratio of 55/45.
SILICONE PSA 6 a silicone-acrylic hybrid pressure sensitive adhesive, prepared according to the techniques taught in WO2007/145996, by a radical polymerization between a silicon-containing PSA, 2-ethylhexyl acrylate and methyl acrylate and is 42% solids in ethyl acetate. Approximately 100 grams of this PSA were dried in a forced air oven at 110° C. for 150 minutes to remove the ethyl acetate solvent prior to use.
SILICONE PSA 7 is a conventional, i.e., uncapped, high tack, industrial silicone PSA that is produced through a condensation reaction of a silanol endblocked polydimethylsiloxane (PDMS) with a silicate resin and is nominally 60% weight solids in xylene and toluene. Approximately 100 grams of this PSA were dried in a forced air oven at 150° C. for 150 minutes to remove the xylene and toluene solvents prior to use.
SILICONE PSA 8 is a conventional, i.e., uncapped, medium tack, industrial silicone PSA that is produced through a condensation reaction of a silanol endblocked polydimethylsiloxane (PDMS) with a silicate resin and is nominally 60% weight solids in xylene and toluene. Approximately 100 grams of this PSA were dried in a forced air oven at 150° C. for 150 minutes to remove the xylene and toluene solvents prior to use.

### Example 5

The following were weighed into a Max 40 cup in the following order: 15 g of SILICONE PSA 1 having a dynamic viscosity of 75M (million) cP (centipoises) at 0.01 Hz, 4.5 g of Pluronic® F-108 nonionic surfactant and 6.4 g of 3 mm spherical glass beads (Fisher). The cup was closed and placed into a DAC-150 SpeedMixer® and the cup was spun at maximum speed (3450 RPM) for two minutes. The cup was opened and inspected. The mixture appeared to be not entirely homogeneous as there were domains of white interspersed with domains of opaque. The cup was placed into a 70° C. oven for 15 minutes after which it was spun again in the DAC 150 SpeedMixer® for two minutes. Inspection of the contents revealed it to be homogeneous in appearance so the composition was diluted with 10.5 g of deionized (DI) water in five increments. The cup was spun at maximum speed after each incremental water addition and the increments were as follows: 1.0 g 1.5 g, 1.5 g, 2.5 g, 4.0 g. After the final dilution, the emulsion had a consistency of paste and was white in appearance. Particle size was determined for the emulsion using a Malvern® Mastersizer 2000 and found to be: Dv50=3.68 μm; Dv90=6.24 μm. A 4 mil (100 μm) wet film of this emulsion was drawn down onto an aluminum Q-Panel and dried for one hour in a 70° C. forced air oven. The resulting film was whitish-gray in appearance and it was slightly tacky. Prior to emulsification, rheological properties of the silicone PSA were determined using a TA Instruments ARES® (New Castle Delaware) rheometer equipped with 25 mm diameter parallel plates and operated at 25 degrees C. in a frequency sweep mode from 0.01 Hz to 80 Hz using a dynamic strain of 10 percent. This polymer has a viscosity of 75,063 Pa-sec. at 0.01 Hz.

### Example 6

The following were weighed into a Max 60 cup in the following order: 17.5 g of SILICONE PSA 2 solids, 7.5 g of Pluronic® F-108 nonionic surfactant and 8.00 g of 3 mm spherical glass beads (Fisher). The cup was closed and placed into a DAC-150 SpeedMixer® and the cup was spun at maximum speed (3500 RPM) for two minutes. The cup was opened and inspected. Inspection of the contents revealed it to be homogeneous in appearance so the composition was diluted with 16.8 g of deionized (DI) water in 7 increments. The cup was spun at maximum speed after each incremental water addition and the increments were as follows: 0.50 g, 1.40 g, 0.62 g, 2.76 g, 1.92 g, 3.42 g and 6.18 g. After the final dilution, the emulsion had a consistency of a cream and was white in appearance. Particle size was determined for the emulsion using a Malvern® Mastersizer 2000 and found to be: Dv50=0.91 μm; Dv90=2.55 μm.

### Example 7

The following were weighed into a Max 60 cup in the following order: 25.43 g of SILICONE PSA 3 solids, 2.83 g of isododecane and 7.98 g of 3 mm spherical glass beads (Fisher). The cup was closed and placed into a DAC-150 SpeedMixer® and the cup was spun at maximum speed (3500 RPM) for four minutes. The cup was opened and inspected. Inspection of the contents revealed it to be homogeneous in appearance, so 5.05 g of Pluronic® F-108 nonionic surfactant was added to the mixture. The cup was closed and spun at maximum speed for 4 minutes. The cup was opened and inspected. Inspection of the contents revealed it to be homogeneous in appearance so the composition was diluted with 22.42 g of deionized (DI) water in 8 increments. The cup was spun at maximum speed after each incremental water addition and the increments were as follows: 1.16 g, 2.04 g, 2.00 g, 2.83 g, 3.02 g, 3.85 g, 3.12 g and 4.40 g. After the final dilution, the emulsion had a consistency of paste and was white in appearance. Particle size was determined for the emulsion using a Malvern® Mastersizer 2000 and found to be: Dv50=9.23 μm; Dv90=19.22 μm.

### Example 8

The following were weighed into a Max 60 cup in the following order: 17.5 g of 7 SILICONE PSA 4 solids, 7.49 g of Pluronic® F-108 nonionic surfactant and 8.01 g of 3 mm spherical glass beads (Fisher). The cup was closed and placed into a DAC-150 SpeedMixer® and the cup was spun at maximum speed (3500 RPM) for five minutes. The cup was opened and inspected. Inspection of the contents revealed it to be homogeneous in appearance so the composition was diluted with 16.8 g of deionized (DI) water in 9 increments. The cup was spun at maximum speed after each incremental water addition and the increments were as follows: 0.68 g, 0.39 g, 0.94 g, 1.47 g, 1.65 g, 3.11 g, 2.11 g, 1.95 g and 4.50 g. After the final dilution, the emulsion had a consistency of a cream and was white in appearance. Particle size was determined for the emulsion using a Malvern® Mastersizer 2000 and found to be: Dv50=0.60 μm; Dv90=1.70 μm.

### Example 9

The following were weighed into a Max 60 cup in the following order: 17.52 g of SILICONE PSA 5, 7.49 g of Pluronic® F-108 nonionic surfactant and 8.00 g of 3 mm spherical glass beads (Fisher). The cup was closed and placed into a DAC-150 SpeedMixer® and the cup was spun at maximum speed (3500 RPM) for three minutes. The cup was opened and inspected. Inspection of the contents revealed it to be homogeneous in appearance so the composition was diluted with 16.7 g of deionized (DI) water in 8 increments. The cup was spun at maximum speed after each incremental water addition and the increments were as follows: 0.58 g, 0.68 g, 1.08 g, 1.06 g, 2.02 g, 3.05 g, 2.53 g and 5.70 g. After the final dilution, the emulsion had a consistency of a cream and was white in appearance. Particle size was determined for the emulsion using a Malvern® Mastersizer 2000 and found to be: Dv50=0.41 μm; Dv90=1.78 μm.

### Example 10

The following were weighed into a Max 60 cup in the following order: 17.5 g of SILICONE PSA 5 solids, 3.5 g of Pluronic® F-108 nonionic surfactant and 8.00 g of 3 mm spherical glass beads (Fisher). The cup was closed and placed into a DAC-150 SpeedMixer® and the cup was spun at maximum speed (3500 RPM) for three minutes. The cup was opened and inspected. Inspection of the contents revealed it to be homogeneous in appearance so the composition was diluted with 14.29 g of deionized (DI) water in 9 increments. The cup was spun at maximum speed after each incremental water addition and the increments were as follows: 0.52 g, 0.75 g, 0.62 g, 0.80 g, 1.26 g, 1.46 g, 2.28 g, 5.00 g and 1.60 g. After the final dilution, the emulsion had a liquid consistency and was white in appearance. Particle size was determined for the emulsion using a Malvern® Mastersizer 2000 and found to be: Dv50=1.38 μm; Dv90=3.44 μm.

### Example 11

The following were weighed into a Max 60 cup in the following order: 17.49 g of SILICONE PSA 6 solids, 7.5 g of Pluronic® F-108 nonionic surfactant and 7.96 g of 3 mm spherical glass beads (Fisher). The cup was closed and placed into a DAC-150 SpeedMixer® and the cup was spun at maximum speed (3500 RPM) for one minute. The cup was opened and inspected. Inspection of the contents revealed it to be homogeneous in appearance so the composition was diluted with 16.7 g of deionized (DI) water in 6 increments. The cup was spun at maximum speed after each incremental water addition and the increments were as follows: 0.54 g, 2.01 g, 2.12 g, 2.85 g, 3.04 g and 6.14 g. After the final dilution, the emulsion had a consistency of a cream and was white in appearance. Particle size was determined for the emulsion using a Malvern® Mastersizer 2000 and found to be: Dv50=3.84 μm; Dv90=8.52 μm.

### Example 12

The following were weighed into a Max 60 cup in the following order: 17.46 g of SILICONE PSA 6 solids, 3.5 g of Pluronic® F-108 nonionic surfactant and 7.96 g of 3 mm spherical glass beads (Fisher). The cup was closed and placed into a DAC-150 SpeedMixer® and the cup was spun at maximum speed (3500 RPM) for two minutes. The cup was opened and inspected. Inspection of the contents revealed it to be homogeneous in appearance so the composition was diluted with 14.08 g of deionized (DI) water in 5 increments. The cup was spun at maximum speed after each incremental water addition and the increments were as follows: 0.83 g, 2.02 g, 2.01 g, 3.32 g and 5.09 g. After the final dilution, the emulsion had a liquid consistency and was white in appearance. Particle size was determined for the emulsion using a Malvern® Mastersizer 2000 and found to be: Dv50=15.04 μm; Dv90=25.61 μm.

### Example 13

The following were weighed into a Max 60 cup in the following order: 17.54 g of SILICONE PSA 7 solids, 7.5 g of Pluronic® F-108 nonionic surfactant and 7.99 g of 3 mm spherical glass beads (Fisher). The cup was closed and placed into a DAC-150 SpeedMixer® and the cup was spun at maximum speed (3500 RPM) for two minutes. The cup was opened and inspected. Inspection of the contents revealed it to be homogeneous in appearance so the composition was diluted with 16.7 g of deionized (DI) water in 7 increments. The cup was spun at maximum speed after each incremental water addition and the increments were as follows: 0.5 g, 1.09 g, 1.42 g, 2.39 g, 2.83 g, 3.37 g and 5.10 g. After the final dilution, the emulsion had a consistency of a cream and was white in appearance. Particle size was determined for the emulsion using a Malvern® Mastersizer 2000 and found to be: Dv50=1.09 μm; Dv90=2.28 μm.

### Example 14

The following were weighed into a Max 60 cup in the following order: 17.52 g of SILICONE PSA 8 solids, 7.5 g of Pluronic® F-108 nonionic surfactant and 8.00 g of 3 mm spherical glass beads (Fisher). The cup was closed and placed into a DAC-150 SpeedMixer® and the cup was spun at maximum speed (3500 RPM) for four minutes. The cup was opened and inspected. Inspection of the contents revealed it to be homogeneous in appearance so the composition was diluted with 16.7 g of deionized (DI) water in 9 increments. The cup was spun at maximum speed after each incremental water addition and the increments were as follows: 0.6 g, 0.42 g, 1.15 g, 1.13 g, 2.05 g, 2.76 g, 2.94 g, 3.09 g and 2.68 g. After the final dilution, the emulsion had a liquid consistency and was white in appearance. Particle size was determined for the emulsion using a Malvern® Mastersizer 2000 and found to be: Dv50=4.19 μm; Dv90=8.98 μm.

1. An aqueous silicone emulsion comprising:
A) 0.5 wt % to 95 wt % of a silicone resin or pressure sensitive adhesive (PSA),
B) 0.1 to 90 wt % of a ethylene oxide/propylene oxide block copolymer,
and sufficient amount of water to sum to 100 weight percent.

2. The aqueous silicone emulsion of claim 1 where the silicone resin is a silicone MQ resin.

3. The aqueous silicone emulsion of claim 2 where the silicone MQ resin comprises siloxy units of the formula (R¹₃SiO_{1/2})ₐ and (SiO_{4/2})_{d}, where R¹ is an alkyl group having from 1 to 8 carbon atoms, an aryl group, a carbinol group, or an amino group, with the proviso that at least 95 mole % of the R¹ groups are alkyl groups, a and d each have a value greater than zero, a+d≧0.8, and the ratio of a/d is 0.5 to 1.5.

4. The aqueous silicone emulsion of claim 1 where the silicone resin is a silsesquioxane resin.

5. The aqueous silicone emulsion of claim 1 where the silsesquioxane resin comprises at least 80 mole % of R³SiO_{3/2} units, where R³ is independently a C₁ to C₂₀ hydrocarbyl, a carbinol group, or an amino group.

6. The aqueous silicone emulsion of claim 5 where R³ is methyl, phenyl, propyl, or a combination of these.

7. The aqueous silicone emulsion of claim 6 where R³ is a mixture of 60-80 mole percent phenyl and 20-40 mole percent propyl.

8. The aqueous silicone emulsion of claim 1 wherein the emulsion is a water continuous emulsion.

9. The aqueous silicone emulsion of claim 1 where the silicone PSA comprises the reaction product of a hydroxy endblocked polydimethylsiloxane and a hydroxy functional silicate resin.

10. The aqueous silicone emulsion of claim 9 where the silicate resin is an MQ resin.

11. The aqueous silicone emulsion of claim 9 where the silicone PSA is a silicone acrylate hybrid composition.

12. A process for making a silicone emulsion comprising;
I) forming a dispersion of;
A) 100 parts of a silicone resin or pressure sensitive adhesive (PSA),
B) 5 to 100 parts of a ethylene oxide/propylene oxide block copolymer,
II) admixing a sufficient amount of water to the dispersion from step I) to form an emulsion,
III) optionally, further shear mixing the emulsion.

13. The process of claim 12 wherein the dispersion formed in step I) consists essentially of
A) 100 parts of a silicone resin or PSA,
B) 5 to 100 parts of an ethylene oxide/propylene oxide block copolymer.

14. The process of claim 12 wherein the silicone resin is a silicone MQ resin or a silsesquioxane resin.

15. The process of claim 12 wherein the ethylene oxide/propylene oxide block copolymer is a poly(oxyethylene)-poly(oxypropylene)-poly(oxyethylene) tri-block copolymer having the formula;
HO(CH₂CH₂O)ₘ(CH₂CH(CH₃)O)ₙ(CH₂CH₂O)ₘH
where m may vary from 50 to 400,
and n may vary from 20 to 100.

16. The process of claim 12 wherein the ethylene oxide/propylene oxide block copolymer is a tetrafunctional poly(oxyethylene)-poly(oxypropylene) block copolymer having the average formula;
[HO(CH₂CH₂O)_{q}(CH₂CH(CH₃)O)ᵣ]₂NCH₂CH₂N[(CH₂CH(CH₃)O)ᵣ(CH₂CH₂O)_{q}H]₂
where q may vary from 50 to 400,
and r may vary from 15 to 75.

17. The process according to claim 12 wherein 5 to 700 parts water are admixed for every 100 parts of the step I mixture to form the emulsion.

18. The process according to any one of claims 12 wherein the water is added in incremental portion such that each portion is less than 30 weight % of the mixture from step I.

19. The emulsion produced by claim 12.

20. A coating composition comprising the emulsion composition of claim 1.

21. A method of forming a coating comprising: applying a film of the silicone emulsion of claim 1 to a surface, and curing the film to form a coating.

22. The cured coating as produced by the method of claim 21.

23. The coating composition of claim 20 wherein the coating is transparent.
